(19) United States
(12) Patent Application Publication
(10) Pub. No.: US 2013/0056959 A1
(43) Pub. Date: Mar. 7, 2013

(54) REAR ATTACHMENT UNIT FOR A MOTOR VEHICLE

(71) Applicants: Bernhard MATHES, Ruesselsheim (DE); Martin OBERFRANK, Trebur (DE)

(72) Inventors: Bernhard MATHES, Ruesselsheim (DE); Martin OBERFRANK, Trebur (DE)

(73) Assignee: GM GLOBAL TECHNOLOGY OPERATIONS LLC, Detroit, MI (US)

(21) Appl. No.: 13/600,426

(22) Filed: Aug. 31, 2012

(30) Foreign Application Priority Data
Sep. 2, 2011 (DE) 10 2011 112 258.7

(51) Int. Cl. B60D 1/48

(52) U.S. Cl. 280/504

(57) ABSTRACT

A rear attachment unit is provided for a motor vehicle body having a support and at least one connecting part connected thereto for fastening to a rear-end support structure of the body. The connecting part can be connected to the support structure by way of at least one fastening section and includes, but is not limited to a deformation structure with a geometrical shaped design for the absorption of mechanical forces.

### CROSS-REFERENCE TO RELATED APPLICATION

This application claims priority to German Patent Application No. 10 2011 112 258.7, filed Sep. 2, 2011, which is incorporated herein by reference in its entirety.

### TECHNICAL FIELD

The technical field relates to a rear attachment unit of a motor vehicle typically embodied as support device or as hitching device, comprising a cross member embodied for example for the arrangement of a trailer coupling, which by means of two lateral connecting parts can be fastened to the support structure of the vehicle body, in particular to rear-end side members of the body.

### BACKGROUND

Rear attachment units, such as for example a trailer hitching device or a rear-end extendable support device for bicycles or similar objects for example require an adequately sturdy attachment to the support structure of the motor vehicle, thus to its body. From DE 196 03 873 A1, for example, a hitching device with a trailer coupling and with a hitch block is known. The hitch block in this case consists of a cross member with face plates, which can be fastened to lateral fastening locations of two fastening bars. Here, at least one connecting point between hitching block and fastening bars on the vehicle is embodied with at least one elastic damping element. By doing so, loads from the driving operation and during dynamic component tests are to be minimized so far that the components can be produced in lightweight design. This is to make possible production of those components from non-ferrite materials, such as for example light metals or plastics.

For rear attachment units, such as for example hitching devices or extendable support devices, however, a minimum dimension of stability and an adequately strong connection of rear attachment unit and support structure components of the body are demanded. On the one hand, the rear attachment unit has to be connected to the body as torsionally-rigid as possible for providing demanded stability and load criteria. On the other hand, a rear attachment unit is to impair a demanded deformation behavior of the motor vehicle body in the event of a collision to the least possible extent.

Further popular connecting concepts for rear attachment units comprise connecting parts arranged laterally similar to the configuration of DE 196 03 873 A1, which are fastened in an overlapping manner both on or in a side member profile of the body. Although a connection of rear attachment unit and side member that is adequately stiff and sturdy in principle can be provided, an invariable doubling of material formed in the connecting region can prove to be disadvantageous in the event of a crash or load however, since such a doubled material section can have a deformation behavior that is entirely different from that of the adjoining components.

It is therefore at least one object to provide a rear attachment unit for a motor vehicle body that is optimized with respect to its deformation behavior, which can be fastened to the support structure of the vehicle body in as sturdy and load-transferring as possible a manner and which on the other hand shows a deformation behavior that is defined in the event of a vehicle collision or provided for this purpose. In addition, other objects, desirable features and characteristics will become apparent from the subsequent summary and detailed description, and the appended claims, taken in conjunction with the accompanying drawings and this background.

### SUMMARY

The rear attachment unit is provided for a motor vehicle body and comprises a support with at least one connecting part connected to the latter for fastening to a rear-end support structure of the body. With respect to a final assembly configuration, the support extends on the vehicle body substantially in vehicle transverse direction (y) while the connecting part is preferably arranged on a lateral outer end section of the support, i.e. oriented in motor vehicle transverse direction (y). Preferably, the support in this case is fastened to the longitudinal frame of the motor vehicle body substantially running in vehicle longitudinal direction. The connecting part connected to the support in this case can be connected to the support structure, preferably to the side member of the vehicle body by way of at least one fastening section. The connecting part furthermore comprises a deformation structure between support and fastening section with a geometrical shape designed for the absorption of mechanical forces.

The connecting part can provide a deformation behavior that is demanded in the event of a crash or load. In particular, a deformation or energy absorption behavior of the support structure can be influenced in an advantageous manner. Through the connecting part provided with a separate deformation structure a demanded intrusion behavior of the support structure is at least not impaired or only insignificantly so.

According to an embodiment it is provided that the connecting part is connectable to the support structure by way of at least two fastening sections spaced from each other. Here, the deformation structure advantageously extends between the two fastening sections. In that the connecting part is connectable to the support structure of the vehicle body by way of at least two fastening sections spaced from each other, an adequately sturdy connection of connecting part as well as rear attachment unit and motor vehicle body can be provided on the one hand. Since in particular the region of the connecting part located between the fastening sections has a geometrical structure and shaping that is optimized for impact and/or energy absorption, the connecting part can also have or support a demanded deformation behavior of the rear attachment unit and the motor vehicle body to be connected thereto.

Upon occurrence of force effects worth mentioning, the combination of rear attachment unit and body support structure provides a deformation behavior that is optimized for occupant protection and demanded. The crash safety of the motor vehicle, in particular in the event of a rear-end collision can be increased because of this.

According to an embodiment, it is provided here in particular that the at least two fastening sections in assembly position on the motor vehicle body come to overlap the same support structure components of the body. In that the connecting part comprises a deformation structure between the two fastening sections it supports a predefined deformation behavior of the support structure components, which otherwise especially through the covering or overlapping arrangement with the fastening section would be subjected to a mechanical reinforcement.

It must be noted here, that the connecting part primarily functions as fastens for the attachment of the rear attachment unit to the support structure of the body, but not as a pure energy absorption element. For this reason, the connecting part is comparatively rigid or inflexible in order to securely and reliably transmit the forces acting on the rear attachment unit during the normal operation of the motor vehicle into the body support structure.

According to an embodiment it is provided that the at least two fastening sections are formed on a continuation of the connecting part substantially extending in vehicle longitudinal direction (x). The continuation with its at least two fastening sections in this case can be preferably fastened in or on a rear-end of a side member of the vehicle body. By way of the connecting part, a direct connection between the support of the rear attachment unit and the rear-end section of the side members of the vehicle body can be created insofar.

Insofar, the support of the rear attachment unit preferably extending in vehicle transverse direction (y) can also function as rear-end transverse connection between the side members running laterally on the motor vehicle rear. The support of the rear attachment unit can form a rear frame structure with the side members of the vehicle body typically running in vehicle longitudinal direction (x) with two connecting parts arranged laterally thereto. Insofar it is provided in particular according to a further embodiment that the connecting part can be connected in a force and load path transmitting manner to the support structure components provided for this purpose, for example to the rear-end side member of the vehicle body via the continuation.

According to a further embodiment, the connecting part has a U-profile like receiving section for the support of the rear attachment unit. The support in this case can be embodied in particular as a closed hollow profile for example of rectangular cross section, which penetrates both legs of the U-profile like receiving section of the connecting part spaced approximately in vehicle transverse direction (y) from each other. The receiving section or the connecting part and the support in this case are typically formed of steel plate and are preferably welded together.

According to an embodiment, the continuation substantially extending forward in vehicle longitudinal direction, in driving direction of the motor vehicle is designed as extension of a leg of the receiving section of the connecting part receiving the support. Insofar, the connecting part can have a U-profile like receiving section and a leg continuation unitarily embodied therewith. The integral embodiment of the continuation provided for the connection to the vehicle body with the receiving section designed for receiving the support imparts the connecting part with major sturdiness in order to be able to provide as sturdy as possible a connection of rear attachment unit and motor vehicle body.

According to a further embodiment, the deformation structure of the connecting part extending between the connecting sections comprises a wave structure extending or propagating in longitudinal direction of its continuation. The wave-like contour of the continuation favors in particular an upsetting of the continuation in continuation longitudinal direction. Since the continuation preferably extends in vehicle longitudinal direction on the support structure of the body, it impairs an upsetting or force and/or energy absorption of a support structure component connected thereto to a far lesser degree as would be the case with a continuation embodied for example linearly as material doubling into a side member. The wavy embodiment of the deformation structure predetermines a defined deformation behavior of the continuation. To this end, the connecting region of rear attachment unit and motor vehicle body can comprise a material doubling required for the connection and a defined or intended crash and deformation behavior.

According to a further embodiment, the free end of the continuation comprising a fastening section has predetermined gap spacing to the adjoining body component on reaching an intermediate assembly configuration on the body. Although the continuation substantially extends parallel to the orientation of the body support structure components, it can however have a certain preload and with its free end stand away at least to a minor degree from the support structure component. Because of the inserting of the continuation in a hollow profile of a bodywork side member for example can be simplified. Through the mentioned preload provided for forming gap spacing, scratching of the body component in particular when inserting the continuation into its hollow profile can be largely bypassed or avoided.

According to a further embodiment, the receiving section of the connecting part comprises a floor extending between the lateral legs, which can be separately connected to the support structure components. In final assembly configuration on the motor vehicle, the floor can extend for example approximately in the plane formed by vehicle longitudinal direction (x) and vehicle transverse direction (y). In that the floor is screwed to the profile floor of the side member correspondingly embodied therewith, for example with a screw connection, fixing of the connecting part with respect to the vehicle vertical direction (z) can be provided.

According to a further embodiment, the connecting part furthermore comprises a plate substantially extending perpendicularly to the spacing of the at least two fastening sections. With this plate, the connecting part can support itself in assembly position in vehicle longitudinal direction (x) on the body. The plate can thereby be separately connected to the body with at least one further fastening element, for example, with one or a plurality of screw connections.

If the continuation comprising the two fastening sections substantially extends in vehicle longitudinal direction (x), the plate is substantially located in a plane formed by vehicle transverse direction (y) and vehicle vertical direction (z). The plate can support itself in particular on a rear-end transverse panel of the motor vehicle body. By way of the fastening element provided in or on the plate, fixing of the connecting part with respect to the vehicle longitudinal direction (x) can be additionally provided. In addition to its extension in vehicle longitudinal direction (x) the continuation has a certain height in vehicle vertical direction (z), so that it can support itself with its two fastening sections on a lateral sidewall extending for example in vehicle vertical direction (z) and in vehicle longitudinal direction (x) of a body side member substantially in vehicle transverse direction (y) and can provide a force transmission in continuation or vehicle longitudinal direction.

According to a further embodiment it is provided in particular that the support of the rear attachment unit preferably embodied as cross member or cross beam is provided with a connecting part on each of its end sections located in transverse direction for fastening to a side member of the body. Because of this, a largely symmetrical fastening of the rear attachment unit to the motor vehicle body can be provided.

According to a further embodiment, the rear attachment unit is designed as hitching device and/or as preferably extendable support device, for example for bicycles or similar objects that can be carried along the motor vehicle. The cross member of the rear attachment unit that can be fastened to the side member structure of the body by way of the connecting part or parts in this case functions as support for example for a trailer coupling and/or as support for a support frame of a bicycle support device extendably mounted thereon.

In a further embodiment, a motor vehicle body with at least one side member substantially extending in vehicle longitudinal direction and a rear attachment unit fastened thereon is provided. The rear attachment unit in this case comprises at least one connecting part with at least two fastening sections spaced from each other in vehicle longitudinal direction. By way of the fastening sections, the rear attachment unit in each case is connected to the side member, preferably screwed.

Between the fastening sections of the connecting part, a deformation structure is provided, which has a geometrical shape designed for the absorption of mechanical forces. The deformation structure, which unitarily interconnects the fastening sections of the connecting part, in this case preferably has a wavy contour, which, in particular when forces acting in vehicle longitudinal direction (x) occur, exhibits a defined and controlled deformation behavior.

Finally, according to a further embodiment, a motor vehicle is provided, which comprises a previously described rear attachment unit and/or a previously described motor vehicle body.

### BRIEF DESCRIPTION OF THE DRAWINGS

The present invention will hereinafter be described in conjunction with the following drawing figures, wherein like numerals denote like elements, and:

FIG. 1 is an insulated perspective representation of a rear attachment unit;

FIG. 2 is the rear attachment unit according to FIG. 1 viewed from the top;

FIG. 3 is an enlarged perspective representation of a connecting part of the rear attachment unit;

FIG. 4 is a further perspective representation of the left connecting part according to FIG. 3;

FIG. 5 is a cross-sectional representation of a connecting part arranged on a side member profile of the motor vehicle body in intermediate assembly configuration; and

FIG. 6 is a sectioned perspective representation of the rear attachment unit on a side member of the motor vehicle body.

### DETAILED DESCRIPTION

The following detailed description is merely exemplary in nature and is not intended to limit application and uses. Furthermore, there is no intention to be bound by any theory presented in the preceding background or summary or the following detailed description.

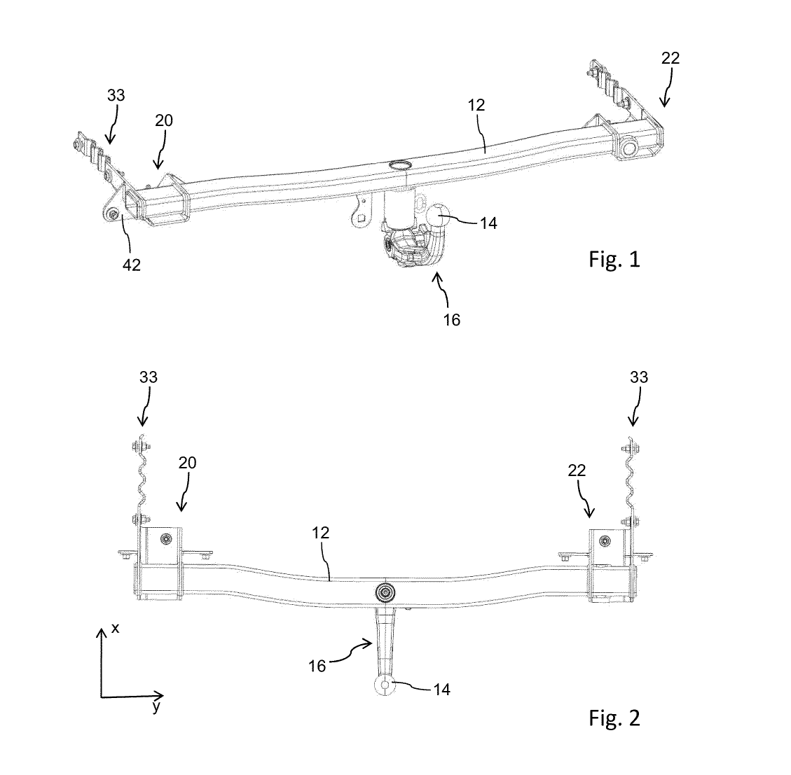

The rear attachment unit 10 completely shown in the FIG. 1 and FIG. 2 in this case is designed as hitching device. It comprises a support 12 designed as cross beam, which by way of two lateral connecting parts 20, 22 can be connected to a motor vehicle body which in this case is not explicitly shown. The support 12 serves for receiving and arranging a trailer coupling 16, which for example comprises a ball head 14 shown in FIG. 1 and FIG. 2 as coupling member.

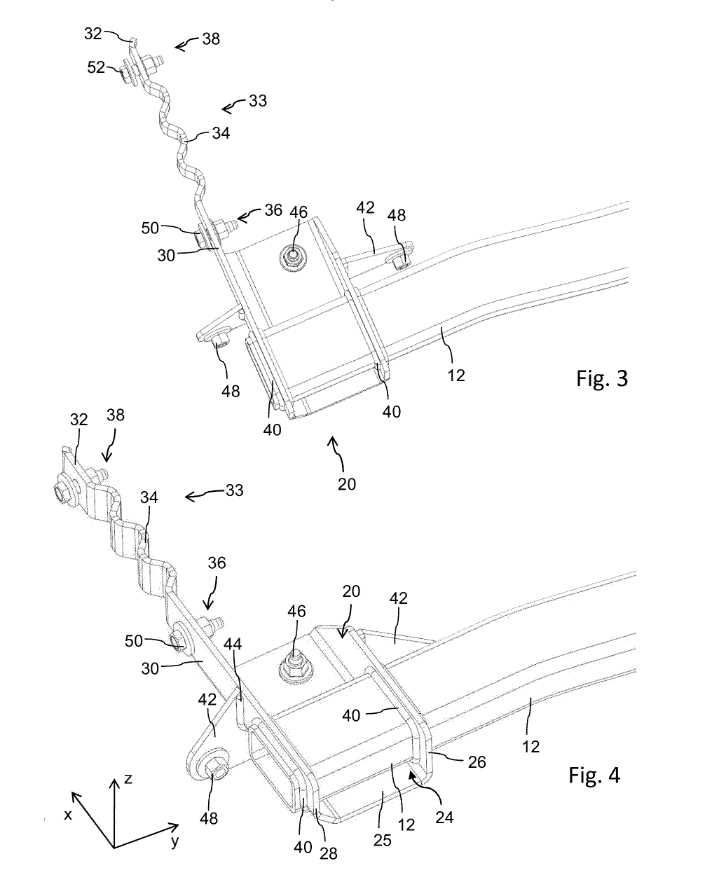

As is evident by means of the enlarged representation according to the FIGS. 3 and 4, the connecting part 20 has a U-profile like section 24 with two lateral legs 26, 28, which are completely penetrated by the support 12. Here, the support 12 is welded to the two legs 26, 28 by way of the weld seams 40 marked in FIG. 4. Located in front of the support 12 in driving direction (x), the floor section 25 of the receiving section 24 interconnecting the two legs 26, 28 comprises a screw connection 46, with which the connecting part 20, as shown in the cross section according to FIG. 6, can be connected to a profile section 66 of a side member 60 of the motor vehicle body running in an overlapping manner in assembly position. By way of this screw connection 46, a mutual fixing of connecting part 20 and side member 60 in vehicle vertical direction (z) can be formed in particular.

From the outside, the U-profile like receiving section 24 of the connecting part 20 is enclosed by a further plate 42 substantially extending in the y-z-plane. The plate 42 is likewise welded to the receiving section 24 of the connecting part 20 in the region of the weld seams 44 shown in FIG. 4. It preferably serves for supporting the connecting part 20 in vehicle longitudinal direction (x). Furthermore, the plate 42 can be connected to a rear-end termination panel of the motor vehicle body which is not explicitly shown in the Figures by way of screw connections 48 indicated in FIG. 3 and FIG. 4. The screw connection 48 insofar provides a fixing of the connecting part (20) in vehicle longitudinal direction (x).

The leg 28 of the connecting part 20 which is located outside with respect to the vehicle transverse direction (y) comprises a continuation 33 which substantially extends forward in vehicle longitudinal direction (x). Facing the U-profile like receiving section 24, the continuation 33 is provided with a first fastening section 36, on its free end, with a further fastening section 38. In the region of the fastening section 36, the continuation 33 comprises a foot section 30 penetrated by a screw connection 50, while in the region of the free end 32 the corresponding fastening section 38 can be provided by means of a further screw connection 52. Between the fastening sections 36, 38 or between the foot or base section 30 and the free end 32 of the continuation 33, a wavy profile 34 is formed, which provides an inherent deformation structure 34. This can provide a defined deformation behavior of the continuation 33 to be connected to a side member 60 shown in FIG. 6 in the event of a load or crash. The continuation 33 with both its sections 30, 32 and via the screw connections 50, 50 provided thereon can be connected to a side wall 65 or a lower half shell of a side member 60 shown in cross section in FIG. 6. The continuation 33 in this case naturally forms a material doubling with the side member section 66.

The wavy profile of the deformation structure 34 furthermore supports an upsetting or deformation of the side member 60 of the vehicle body due to a crash, so that said side member is able to develop a demanded deformation behavior and connected with this an energy-absorbing effect in particular for protecting the vehicle occupants. The continuation 33 preferably comes to lie with a side wall 65 of the lower half shell 66 of the side member 60, so that by way of the shown screw connection 50, 52, a fixing of the connecting part 20 relative to the side member 60 in vehicle transverse direction (y) can take place.

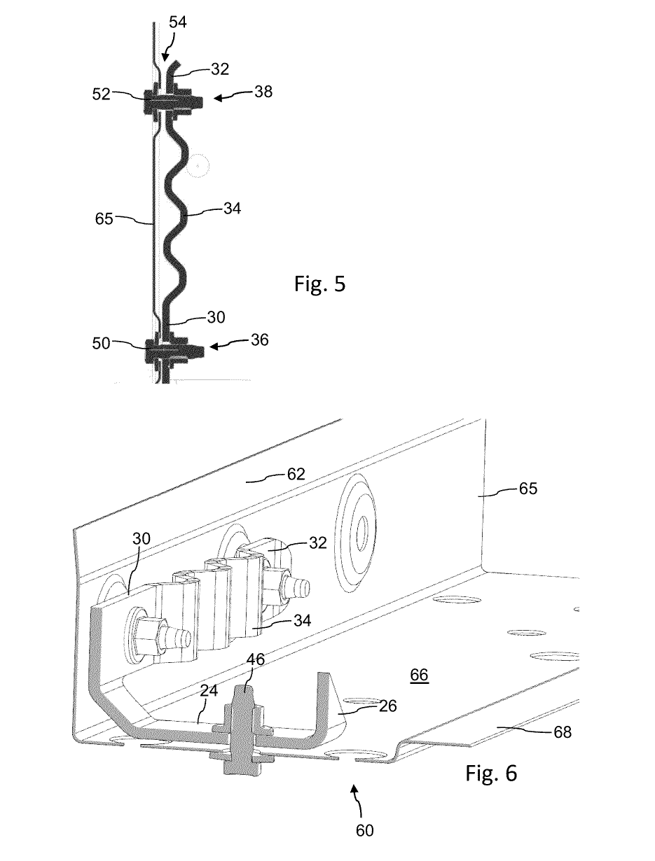

It is noted, in addition, that the screw connections 46, 48, 50 for example shown in FIG. 4 provide a kind of three-point nodal screw connection, by means of which the connecting part 20 can be fastened to the motor vehicle body in all three space directions (x, y, z). In addition, an intermediate assembly configuration of the rear attachment unit or of the connecting part 20 on the side member 60 of the vehicle body is shown in FIG. 5. In this configuration, the connecting part 20 is already in an intended position. However, the screw connections 50, 52 are not yet tightened. In particular, in the region of the free end 32 of the continuation 33, a gap 54 is noticeable between the end section 32 and the side wall 65 of the side member 60.

The continuation 33 thus protrudes slightly to the inside and accordingly has a preload directed towards the vehicle middle, which for example facilitates the inserting of the continuation 33 in the cross-sectional profile of the side member 60 formed by the half shells 67 and counteracts or prevents a possible scratching of the inside of the side member 60. The side member structure 60, as is shown in cross section in FIG. 6, comprises two half shells 66 formed corresponding to each other, of which merely the lower half shell with the side wall 65 located on the outside is shown. A further half shell corresponding to this one is welded to the lower half shell 66 in the region of the marginal flange sections 62, 68 for forming a closed cross-sectional profile.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A rear attachment unit for a body of a motor vehicle, comprising:
a support;
a connecting part connected to the support and configured for fastening to a rear-end support structure of the body; and
a first fastening section configured to connect the connecting part to the rear-end support structure that comprises a deformation structure with a geometrical shape that is configured to absorb mechanical forces.

2. The rear attachment unit according to claim 1,
wherein the connecting part is connectable to the rear-end support structure with a second fastening section spaced from the first fastening, and
wherein the deformation structure is provided between the first fastening section and the second fastening section.

3. The rear attachment unit according to claim 2, wherein the first fastening section and the second fastening section in an assembly position come to lie in an overlapping manner.

4. The rear attachment unit according to claim 2, wherein the first fastening section and the second fastening section are formed on a continuation substantially extending in a vehicle longitudinal direction.

5. The rear attachment unit according to claim 4, wherein the connecting part by way of the continuation is connectable to the support in a force-transmitting manner.

6. The rear attachment unit according to claim 4, wherein the connecting part has a U-profile receiving section for the support.

7. The rear attachment unit according to claim 6, wherein the continuation is an extension of a leg of the U-profile receiving section.

8. The rear attachment unit according to claim 6, wherein the deformation structure comprises a wave structure propagating in longitudinal direction of the continuation.

9. The rear attachment unit according to claim 6, wherein a free end of the continuation comprising a fastening section upon reaching of an intermediate assembly configuration comprises a predefined gap spacing from the body.

10. The rear attachment unit according to claim 6, wherein the U-profile receiving section comprises a floor extending between two lateral legs, which are separately connectable to the support.

11. The rear attachment unit according to claim 2, wherein the connecting part comprises a plate substantially extending perpendicularly to a spacing of the first fastening section and the second fastening section by which the connecting part is self-supportable on the body in assembly position in a vehicle longitudinal direction.

12. The rear attachment unit according to claim 11, wherein the plate can be separately connected to the body with a fastening element.

13. The rear attachment unit according to claim 1, wherein the rear attachment unit is configured to form a hitching device.

14. The rear attachment unit according to claim 1, wherein the rear attachment unit is configured to form an extendable support device.

15. A motor vehicle body, comprising:
a side member substantially extending in a vehicle longitudinal direction;
a rear attachment unit fastened to the side member, the rear attachment unit comprising:
a support;
a connecting part connected to the support and configured for fastening to a rear-end support structure of the motor vehicle body; and
a first fastening section configured to connect the connecting part to the rear-end support structure that comprises a deformation structure with a geometrical shape that is configured to absorb mechanical forces.

16. The motor vehicle body according to claim 15,
wherein the connecting part is connectable to the rear-end support structure with a second fastening section spaced from the first fastening, and
wherein the deformation structure is provided between the first fastening section and the second fastening section.

17. The motor vehicle body according to claim 16, wherein the first fastening section and the second fastening section in an assembly position come to lie in an overlapping manner.

18. The motor vehicle body according to claim 16, wherein the first fastening section and the second fastening section are formed on a continuation substantially extending in the vehicle longitudinal direction.

19. The motor vehicle body according to claim 18, wherein the connecting part by way of the continuation is connectable to the support in a force-transmitting manner.

20. The motor vehicle body according to claim 15, wherein the connecting part has a U-profile receiving section for the support.
